(19) United States
(12) Patent Application Publication
(10) Pub. No.: US 2006/0222747 A1
(43) Pub. Date: Oct. 5, 2006

(54) Process for packaging foods and packaged product

(75) Inventor: Samuel Thomas, Beaufort, NC (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Ocean Technology, Inc.

(21) Appl. No.: 11/397,605

(22) Filed: Apr. 5, 2006

Related U.S. Application Data
(60) Provisional application No. 60/668,086, filed on Apr. 5, 2005.

(51) Int. Cl. A23L 3/10

(52) U.S. Cl. 426/407

(57) ABSTRACT

A packaged shellfish product and a process for producing the shellfish are provided by the invention. The shellfish is heat-treated to partially cook the shellfish followed by rapid cooling to stop the cooking process. The partially cooked shellfish is then packaged in a sealed container and heated for sufficient time and temperature to fully cook the shellfish. The resulting packaged shellfish has an extended refrigerated shelf life. In one embodiment, the packaged shellfish is stable for about 45-60 days without loss of flavor or texture.

### CROSS-REFERENCE TO RELATES APPLICATIONS

This application claims the benefit under 35 U.S.C. §119(e) of provisional application Ser. No. 60/668,086, filed Apr. 5, 2005, the disclosure of which is incorporated herein by reference in its entirety.

### FIELD OF THE INVENTION

The present invention is directed to a process for producing a packaged food product having an extended shelf life. Examples of foods that can be processed according to the invention include fish, fish fillets, shellfish, crustaceans, shrimp, lobster, crab, crab meat as well as fruits and vegetables. The invention is also directed to a process for treating and cooking shellfish to obtain a packaged product having an extended shelf life when refrigerated. The invention is particularly directed to a process for packaging a refrigerated shellfish, and particularly shrimp that has an improved taste and texture compared to the prior packaged products.

### BACKGROUND OF THE INVENTION

Shellfish is typically packaged and processed for sale to the consumer either as fresh shellfish or in frozen form. Fresh shellfish has a very short storage life and requires constant and careful temperature control to ensure the fresh taste and texture. Frozen seafood and shellfish have longer storage life and the convenience of being thawed immediately prior to cooking and consumption by the consumer. The processing of the seafood and shellfish by quick freezing retains the taste and texture.

The storage life of seafood and shellfish can be increased by cooking prior to packaging or canning. Typically, seafood and particularly shellfish quickly lose flavor when frozen after cooking. In addition, the texture and mouth feel of the seafood and shellfish quickly deteriorate when frozen.

Various processes have been proposed to prepare packaged seafood and shellfish products in a ready-to-eat form. One example of such a process is disclosed in U.S. Pat. No. 3,852,486 to Walker et al. The process as disclosed treats the shellfish meat to produce a pasteurized product. The shellfish meat such as crab or shrimp is initially cooked in cooking water according to conventional practices. The fully cooked shellfish meat is dipped in a water bath containing 100 ppm of chlorine. The shellfish meat is drained and then immersed in a salt solution to inhibit the growth of microorganisms. The treating solution also contains an antibacterial agent and a strong organic acid such as citric or ascorbic acid. The shellfish is treated with the solution for sufficient time to penetrate the meat. Thereafter, the meat is packaged and heat pasteurized.

Another process is disclosed in U.S. Pat. No. 4,971,821 to McIntyre. The process thermally treats seafood products such as shrimp. The process generally includes blanching in an aqueous solution containing 3.95% salt. The treated shrimp is then rinsed to cool and packaged into cans. The cans are then filled with a solution of aldonic acid or its lactones.

The prior processes for treating and processing of shellfish and particularly shrimp have met with limited success. Although the prior processes are effective in extending the shelf life of the treated shellfish, the resulting shellfish has a poor texture and mouth feel that is tough and has pulp-like texture. The shellfish also has an off-color and off-flavor with little or no similarity to freshly cooked and prepared shellfish. Accordingly, there is a continuing need in the industry for an improved process for treating and packaging shellfish, and particularly shrimp.

### SUMMARY OF THE INVENTION

The present invention is directed to a process for producing a packaged food product having an extended shelf life. The invention is particularly directed to a process for treating seafood and particularly shellfish to obtain a refrigerated product having an extended shelf life compared to the prior processes. The process of the invention is able to retain the taste, texture and appearance of freshly prepared shellfish. Examples of foods that can packaged according to the invention include seafood such as fish, fish fillets, shellfish, crustaceans, shrimp, lobster, crab, crab meat as well as fruits and vegetables.

Accordingly, a primary feature of the invention is to provide a process that is suitable for processing shrimp and crab. The resulting shrimp and crab can be stored under refrigeration for up to three months, and preferably up to six months, while retaining the fresh taste and texture.

Another aspect of the invention is to provide a process for treating and packaging shellfish to extend the life of the resulting product without the use of preservatives or antibacterial agents. The process effectively heat-treats the shellfish without the use of preservatives and then cools the shellfish to obtain a refrigerated product having an extended shelf life. Compared to other processes, the heat treatment cooks the shellfish and provides a mild pasteurization compared to the high temperature treatment of the prior processes.

The features of the invention are also attained by providing a process for producing a packaged refrigerated shellfish product that retains a fresh appearance, taste and texture.

The process of the invention is particularly suitable for preparing a packaged shrimp product that retains the fresh appearance and fresh taste with the crisp texture of freshly prepared shrimp. The packaged shrimp can be stored under refrigeration for an extended period of time without loss of taste or texture.

In one embodiment, raw shrimp is heat treated and partially cooked in hot water or steam and then quickly cooled to stop the cooking process. The shrimp is preferably cooled by contacting with cool water having a low concentration of an acid. Thereafter, the partially cooked shrimp is packaged in a sealed container and heat-treated to complete the cooking process without overcooking the shrimp. To prevent overcooking, the container is removed from the heat source and quickly cooled and stored in a refrigerated environment.

These and other aspects of the invention are basically attained by providing a process for preparing a packaged shellfish product which comprises the steps of heating raw shellfish to a temperature and for a time sufficient to produce a hot partially cooked shellfish. The hot partially cooked shellfish is cooled to a temperature of 30° C. or less to stop the cooking process and produce a cooled partially cooked shellfish. The cooled partially cooked shellfish is placed into a container at an ambient temperature of about 18° C. to about 24° C., and thereafter the container is hermetically sealed. The partially cooked shellfish in the container is heated to a temperature of at least 62° C. for a time sufficient to produce a fully cooked shellfish. Immediately thereafter, the shellfish is cooled to stop the cooking process and the shellfish is stored at a temperature below room temperature.

The various aspects of the invention are also attained by providing a process for preparing a packaged shrimp product which comprises the steps of heating raw shrimp to a temperature and for a time sufficient to produce hot partially cooked shrimp. Immediately thereafter, the hot partially cooked shrimp is contacted with chilled water containing an effective amount of an edible acid to treat the partially cooked shrimp and reduce the temperature of the shrimp to a temperature of 32° C. or less to stop the cooking of the shrimp and produce a cooled partially cooked shrimp. The cooled partially cooked shrimp is placed in a container at a temperature of about 15° C. to about 28° C. and thereafter, the container is hermetically sealed. The container and the partially cooked shrimp are heated to a temperature of at least 62° C. for a time sufficient to produce a hot fully cooked shrimp. Immediately thereafter, the hot fully cooked shrimp is cooled to a temperature of not more than 10° C. and the fully cooked shrimp is stored under refrigeration.

The aspects of the invention are also attained by providing a stable packaged shellfish product prepared by the process comprising the steps of heating and partially cooking raw shellfish to a temperature and for a time sufficient to produce a partially cooked shellfish. Immediately thereafter, the internal temperature of the partially cooked shellfish is reduced to a temperature of 32° C. or less to stop the cooking of the shellfish and produce a cooled partially cooked shellfish. The cooled partially cooked shellfish is placed in a container at an ambient temperature of about 18° C. to about 24° C. and thereafter the container is hermetically sealed. The container and the partially cooked shellfish are heated to an internal temperature of at least 62° C. for a time sufficient to produce a fully cooked shellfish. Immediately thereafter, the container and shellfish are cooled to stop the cooking, and thereafter the shellfish is stored under refrigeration.

The advantages and features of the process of the invention and the resulting product will become apparent from the following detailed description of the invention which discloses various embodiments of the invention.

### BRIEF DESCRIPTION OF THE DRAWINGS

The following is a brief description of the drawings, in which:

FIG. 1 is a perspective view of the container and condiment package in one embodiment of the invention;

FIG. 2 is a side view of the assembled package;

FIG. 3 is a perspective view of the assembled package of FIG. 2 enclosed in a folded cardboard blank; and

FIG. 4 is a top view of the cardboard blank for forming the folded package of FIG. 3.

### DETAILED DESCRIPTION OF THE INVENTION

The present invention is directed to a process for producing a food product having an extended shelf life. The invention is particularly directed to a product for treating and packaging shellfish and other seafood to obtain a product with an extended shelf life when refrigerated.

The process of the invention is carried out to provide a packaged shellfish such as shrimp and/or crab meat that has a refrigerated shelf life of at least three months, and preferably up to about 6 months. In other embodiments, the process and package of the invention can be used to prepare fish and fish products, lobster and other seafood, as well as fruits and vegetables.

The prior processes for packaging and treating shellfish are not able to obtain a product that is both stable for extended periods of time and is able to retain a fresh texture and mouth feel of freshly prepared shellfish. Typically, the prior processes fully cook or otherwise treat the shellfish to pasteurize the shellfish, but produce a tough and hard product that has an undesirable mouth feel. Although the prior processes produce a product having an extended shelf life, the resulting product has an undesirable taste and texture.

The process of the invention produces a food product that has good flavor, texture, and color that can be packaged in transparent or translucent packaging materials to display the food product. In one preferred embodiment, the shellfish is packaged in one container and a suitable sauce or condiment is packaged in a second container. The two containers can then be secured together by a suitable wrapping, package or fastener. For example, a shrink wrap type of material can be used to secure the two containers together. Alternatively, or in combination with the shrink wrap, a cardboard blank can be used to form a folded outer packaging to secure the two containers together. In another embodiment, one container can snap together with the other to form a unitary package.

The process of the invention basically comprises heat-treating raw shellfish to cook or partially cook the shellfish and immediately chilling the cooked or partially cooked shellfish. The cooked or partially cooked shellfish is then packaged in hermetically sealed containers and thermally treated to a temperature and for a time sufficient to reduce spoilage of the shellfish and to produce a fully cooked shellfish to obtain an extended shelf life. Immediately thereafter, the containers are cooled to stop the cooking process and the containers are then stored at a temperature sufficient to provide an extended shelf life. In one preferred embodiment, the heat-treating step of the sealed container kills the pathogens-on the surface of the shellfish and within the container to inhibit the formation of offensive odors during storage and to extend the refrigerated shelf life.

The process of the invention provides a controlled thermal, heat-treating process for preparing a packaged shellfish product that retains the desirable taste, color and texture for an extended period of time. The thermal process carefully controls the temperature and heating time of the shellfish to prevent overcooking while being sufficient to cook the shellfish and kill pathogens that might remain on the surface of the shellfish. The temperature and time that the shellfish is exposed to the heat source takes into consideration the various factors that determine the properties of the final product. Shellfish, and particularly crab and shrimp, are sensitive to overcooking and can be overcooked quickly. Overcooking shrimp, for example, results in poor taste and texture.

In the following discussion, the lag time and the latent heat in the shellfish are considered in determining the heating temperature and time that the shellfish is exposed to the heat. As discussed hereinafter in greater detail, the shellfish is quickly cooled after each heat treatment step to stop the cooking process as quickly as possible, thereby preventing overcooking and retaining the desired taste, texture and mouth feel. In the following description of the invention, the initial heating temperature and time refers to an internal temperature of the shellfish rather than the exposure time to the heat source. For example, the latent heat after the shellfish is removed from the heat source until the internal temperature of the shellfish is reduced to a selected temperature is considered in determining the heating time and the length of time of exposure to the heat source. In addition, the latent or residual heat in the shellfish after the heat treatment steps determine how quickly the shellfish is exposed to a cooling medium to reduce the temperature of the shellfish below the cooking temperature.

The process of the invention is particularly suitable for preparing packaged shellfish such as shrimp and crab. In other embodiments, other forms of seafood can be processed and packaged to extend the shelf life. In the following example, the seafood is shrimp, although it is to be understood that the process can be modified for the type of seafood being processed. For example, crab or fish can be processed and packaged according to the process by selecting the appropriate time and temperatures. When the seafood product is shrimp, fresh raw shrimp is obtained having the proper size and quality for the intended end product.

In the following discussion, the process is for treating and packaging shrimp. The time and temperatures described herein are in reference to packaging shrimp, although it will be understood that other shellfish can be processed in a similar manner. The time and temperatures described herein are in reference to treating uncooked shrimp. The time and temperatures can be adjusted as needed to effectively treat the selected shellfish.

In one embodiment of the invention, shrimp are prepared and packaged in a fully cooked ready-to-eat form. In particular, the shrimp are peeled, deveined and ready for consumption. The resulting shrimp are typically packaged as shrimp cocktail that is ready for consumption.

In one embodiment of the invention, fresh uncooked shrimp is obtained that is peeled and deveined. Alternatively, the shrimp can be previously frozen and thawed according to conventional practices. The raw shrimp is heated-treated in a first heating step to partially cook the shrimp quickly under controlled temperature and for a controlled time period. In preferred embodiments, the shrimp is partially cooked at a temperature and for a time that is less than a normal or conventional time required to fully cook the shrimp. At the end of the first heat treatment step, the shrimp is only partially cooked and generally not considered to be in an edible form according to standard practices. In one preferred embodiment of the invention, the raw shrimp is placed on a conveyor in a thin layer, and preferably in a single layer, and passed through a continuous steam tunnel. The conveyor passes through the steam tunnel to expose the shrimp to live steam under atmospheric pressure. The live steam quickly heat-treats the outer surfaces of the shrimp to partially cook the shrimp without cooking the shrimp completely through. In preferred embodiments, the shrimp is exposed to the steam for a period of about one minute to about 1.5 minutes. The speed of the conveyor and the length of the steam tunnel are selected to provide the desired heat treatment time. In one embodiment, the steam heats the internal temperature of the shrimp to a temperature of about 70° C. to about 90° C. The thin or single layer of the shrimp on the conveyor provides uniform exposure to the steam and substantially uniform heat treatment.

The conveyor exits the steam tunnel and continuously carries the shrimp through a continuous spray of chilled water to reduce the temperature of the shrimp quickly to about 32° C. or below. Typically, the shrimp is exposed to the chilled water spray for about 45 seconds. The cold water spray is generally at a temperature of about 4° C. or less. The length of time the partially cooked shrimp is exposed to the cold water spray varies depending on the size of the shrimp, the temperature of the water spray and the temperature of the shrimp at the time the shrimp leaves the steam tunnel or first heat treatment step. In preferred embodiments of the invention, the temperature of the heat-treated, partially cooked shrimp is reduced as quickly as possible to a temperature of 32° C. or below to stop the cooking process and prevent further heat treatment. In one preferred embodiment, the shrimp is quickly cooled to a temperature of about 18° C. to about 24° C. Preferably, the cooling step is carried out to limit the first heat treatment step so that the shrimp is at a temperature of 90° C. and above for no more than one minute and at a temperature of 70° C. and above for no more than 1.5 minutes.

The water used to spray the shrimp to cool the heat-treated shrimp preferably contains about 0.5 wt % to about 2 wt % of an edible acid. The preferred edible acid is citric acid, although other acids can be used as known in the art. The concentration of the acid in the chilling water provides a pH slightly below 7 and generally in the range of about pH 6.0 to pH 6.9. In one embodiment, the chilling water has a pH of about pH 6.5 to about pH 6.9. The low concentration of the acid in the chilling water has been found to inhibit the loss of color and maintain the fresh appearance of the shrimp during packaging. In addition, the low concentration of the acid treats the surface of the shrimp to help retain the crisp firm texture of the shrimp during long term storage. In some embodiments of the invention, the acid in the chilling water can provide some antimicrobial effect on the surface of the shrimp. The chilling water spray is applied to the shrimp for sufficient time to reduce the temperature to the desired level without the water or acid impregnating the shrimp to any substantial degree. In preferred embodiments, the chilling water does not contain salts such as sodium chloride, antibacterial or antimicrobial agents or chlorine that can alter the taste and texture of the shrimp. In one preferred embodiment of the invention, the chilling water consists essentially of water and about 0.5 to 2 wt % citric acid, and preferably about 0.5 wt % to about 1.5 wt % citric acid. The chilling water contacts the shrimp to cool the shrimp quickly. Preferably, the shrimp does not contact the chilling water for an extended period of time that can cause the shrimp to absorb the water or any compounds contained in the water.

In an alternative embodiment, the peeled deveined shrimp are placed in baskets and heat-treated by immersing in boiling water for about 30 seconds to about one minute, and preferably about 40 seconds to about 50 seconds. The heat treatment step in the boiling water effectively blanches the shrimp quickly and does not completely cook the shrimp. Preferably, the shrimp placed in the basket is in a sufficiently thin layer so that all of the shrimp in the basket is uniformly heat-treated, thereby minimizing hot or cold spots and inconsistent heat-treatment. The heat-treatment step to partially cook or blanch the shrimp partially cooks the outer surface of the shrimp without completely cooking the internal portion of the shrimp, thereby retaining the texture and color of freshly cooked shrimp during long term storage. After the selected heat-treatment time, the basket and the shrimp are removed from the boiling water and immediately immersed in cold water to stop the cooking process as quickly as possible. In one embodiment, the chilling water is an ice slush at a temperature of 4° C. or below. The hot, partially cooked shrimp is immersed in the ice slush to cool the internal temperature of the shrimp below the cooking temperature, and preferably below 32° C. The ice slush preferably contains about 0.5 wt % to about 2 wt % of an edible acid such as citric acid. As in the previous embodiment, the hot heat treated shrimp is contacted with the chilled water bath for a time sufficient to cool the internal temperature of the shrimp without impregnating the shrimp with the chilling water or compounds contained in the chilling water.

Once the shrimp are heat-treated in the initial heating step and cooled to a temperature below the cooking temperature, the shrimp are ready for packaging in a suitable container. In preferred embodiments of the invention, the containers are rigid plastic containers having a size and dimension sufficient to provide a single portion for consumption by the ultimate consumer. The containers are preferably rigid plastic that are transparent or translucent to provide a pleasing visible appearance to the consumer. In one embodiment, the containers have a shape and dimension to hold about 8 ounces of the treated shrimp. The shrimp is drained from the chilling water and placed in the containers. Preferably, the liquid phase in the container is less than 10% of the total net weight of the shrimp. A suitable cover or lid is placed over the container and sealed by a suitable sealing or seaming apparatus as known in the art. Preferably, the container is sealed at atmospheric pressure and room temperature.

The hermetically sealed containers containing the shrimp are then subjected to a second heat-treatment step to heat-treat the shrimp and completely cook the shrimp while enclosed within the sealed container. The heating step is for a sufficient time and at a suitable temperature to completely cook the shrimp uniformly without overcooking portions of the shrimp within the container. In one embodiment of the invention, the containers are subjected to a heat source to heat the internal temperature of the container and the shrimp to about 62° C. to about 71° C. for about 30 seconds to about 2 minutes. The actual heating time is determined by the initial internal temperature of the container and thus the internal temperature of the shrimp. Heating the container to attain an internal temperature of 70° C. for about 30 seconds effectively heat-treats the shrimp to fully cook the shrimp and kill pathogens on the outer surface of the shrimp during packaging. Heat-treating the container under these conditions results in a stable product that can be refrigerated for an extended time, retains the original color, taste and texture of freshly cooked shrimp. In one preferred embodiment, the packaged shrimp has a refrigerated shelf life of about 45-90 days. It has been found that the short heat treatment times and controlled temperatures produce a refrigerated product that retains the crisp fresh taste. The same effect can also be attained by subjecting the container to a heat source to attain an internal temperature of about 62° C. while heating for about 2 minutes. It will be understood that variations in the time and temperature can be made to attain the desired result. While a higher temperature and long cook time can extend the refrigerated shelf life further, the resulting product does not have the desired crisp taste and texture.

The containers and the shrimp within the containers can be heated by a suitable heat source. In one embodiment, the containers are immersed in a hot water bath at a temperature of at least 90° C. The hot water bath provides a rapid transfer of heat through the container and into the interior portion of the container, thereby quickly and uniformly heat-treating the shrimp within the container. The hot water bath reduces the incidence of overheating the shrimp adjacent the outer surface of the container while under heating the interior portions of the container since the heat transfer between the hot water and the shrimp is rapid. The process of the invention is intended for commercial operations where a large number of containers are heat-treated simultaneously. Preferably, the containers are spaced apart and arranged to provide substantially uniform exposure to the heating medium so that the shrimp in each of the containers are substantially uniformly heat-treated. The size and shape of the containers and the volume of the shrimp contained within the container are also taken into consideration to determine the time needed to reach the desired temperature and maintain the temperature for the required time. Experimental testing can be carried out for a specific arrangement of the containers to ensure that the proper internal temperature is attained. The time that the containers are exposed to the heating medium is selected to ensure a minimum temperature and time is attained for each of the containers.

The time and temperature for the heat-treatment steps take into account the latent heat or residual heat in the containers after being removed from the heating medium. The residual heat in the containers and the shrimp from the time the containers are removed from the heating medium such as the hot water bath, cause the heat-treatment to continue even after the containers are removed from the heating medium. Thus, the time for the heat treatment step is based on the time the internal temperature of the containers and the shrimp reach the minimum temperature until the internal temperature falls below a minimum temperature regardless of the length of time the containers are exposed to the heating medium. In the first heat treatment step, the heating time is determined for the period between the time the internal temperature reaches the selected temperature and the time the temperature of the shrimp is reduced to 32° C. or below by the chilling water. In one preferred embodiment, the time period for the second heat-treatment step is calculated from the time the internal temperature of the containers and the shrimp reach a minimum of 62° C. until the internal temperature of the containers fall below 62° C.

The containers and the heat-treated shrimp are quickly cooled to lower the temperature of the shrimp below a cooking temperature thereby stopping the cooking process. The rapid cooling of the shrimp prevents the latent heat in the shrimp and containers from continuing the cooking process and prevents overcooking of the shrimp which can cause deterioration in the color, texture and taste of the shrimp after storage. In one preferred embodiment, the containers are removed from the heating medium and immediately immersed in a cold water bath to quickly reduce the temperature of the containers and the shrimp. Typically, the cold water bath is at a temperature of about 4° C. or less. The internal temperature of the containers and the temperature of the shrimp are quickly reduced to 10° C. or below, and preferably about 4° C. or below. The heating time of the second heat-treatment step includes the time between the removal of the heat source from the containers and the time the internal temperature of the shrimp is reduced to stop the cooling process. The chilled containers and shrimp are then removed from the water bath and placed in a refrigerated storage facility to maintain the temperature at about 4° C. or below. The refrigerated product is stable for at least 45 days, and preferably up to about six months, while retaining the desirable taste, color and crisp texture. Typically, the refrigerated product is stable for about 45 to 60 days.

The process of the invention effectively controls the temperature and the time that the shellfish such as the shrimp are exposed to selected temperatures. In the above example for treating and packaging shrimp, the shrimp after the initial heat-treatment, is maintained at a temperature below the cooking temperature until the shrimp is packaged in the sealed container and ready for the second heat treatment. In preferred embodiments, the temperature of the shrimp is at about 18° C. to about 24° C. at the time the shrimp is placed in the container and the container is sealed. The ambient temperature of the container and the shrimp at the time of sealing the container has an effect on the internal pressures during the subsequent heat-treating step and the refrigeration step during storage. Preferably, the internal temperature of the container at the time of sealing is not less than 18° C. Temperatures below 18° C. can cause the internal pressure of the sealed container to rise during the subsequent heat-treating step, which can deform the plastic container or rupture the seal. Temperatures above 24° C. at the time of sealing the container can also cause the plastic container to deform and the seal to rupture during the subsequent heat-treating step and the cooling step during storage.

The internal temperature of the sealed containers is preferably maintained at a temperature of about 18° C. to about 24° C. between the time the containers are sealed and the time the containers are subjected to the heating medium in the subsequent heat-treating step. The temperature range is desirable to enable the container and the shrimp to quickly increase to the desired second heat-treating temperature when exposed to the heating medium. Cooling the sealed containers below this temperature range can result in the shrimp positioned along the outer edges of the container reaching the intended temperature while the internal temperature of the container at the center is well below the desired temperature. Maintaining the temperature within this temperature range prior to subjecting to the heating medium in the second heat-treatment step minimizes overheating and overcooking of the shrimp along the outer edges of the container. The initial product temperatures prior to the second heat-treatment are important to the overall process schedule and the timing of the heat-treatment step. Therefore, it is particularly desirable to maintain the internal temperature of the containers above the minimum temperature until the containers are subjected to the heating medium. The internal temperature of the product can be measured just prior to sealing the container by random sampling.

The process of the invention is a thermal process for treating shellfish, and particularly shrimp, in a manner to retain the taste, texture and color of the shellfish without the use of preservatives or salt solutions. The hermetically sealed containers are heat-treated under mild conditions to complete the cooking of the shellfish and kill pathogens that may be in or on the shellfish after the first heat-treating step.

In another embodiment, crab meat can be heat-treated and packaged in a container in a similar manner to obtain a stable product. The crabs are initially cooked in a retort under pressure to obtain fully cooked crabs. The crabs are then cooled such as by forced air cooling and refrigerated for up to 16 hours, and typically about 12-16 hours. The crabs are then picked and the crab meat is then placed in containers in a manner similar to the previous embodiment. The containers are sealed and then heat-treated to attain an internal temperature of about 62° C. to about 71° C. for about 30 seconds to about 2 minutes. The heat-treatment is sufficient to kill or eliminate pathogens and to obtain a product that is stable for 45-60 days under refrigeration. The resulting product is refrigerated at a temperature of about 2-4° C.

In preferred embodiments of the invention, the shellfish such as the shrimp are packaged in single serving sized containers. The packaged shellfish preferably has a liquid phase of not more than 10 wt % based on the net weight of the shellfish. In one embodiment, the shrimp is packaged as shrimp cocktail where the shrimp is packaged in a sealed container and a cocktail sauce or other condiment is packaged in a separate container. During use, the consumer opens the container containing the shrimp and the container containing the condiment. The container for the shellfish and the condiment are preferably packaged together and secured together by a suitable packaging material such as a shrink wrap film, folded cardboard blank or a combination thereof. Typically, the condiment is a tomato-based cocktail sauce or a mustard sauce.

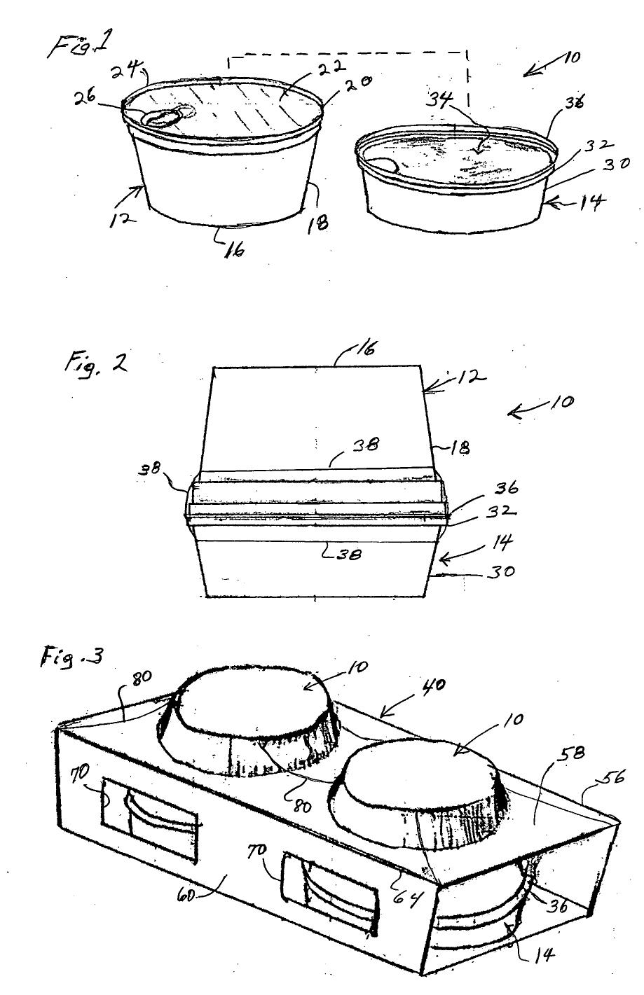

The prepared shellfish can be packaged in containers of various sizes and shapes. Preferably, the containers are single serving size that allows uniform and rapid heating of the shellfish during the second heat treatment step. Referring to FIGS. 1-4, one example of a suitable package assembly 10 includes a first container 12 having a cup shape and a second container 14 defining a condiment package. The container 12 in the embodiment shown has a bottom wall 16 and a frustoconical shaped side wall 18 terminating at an open top end having an outwardly extending lip 20. The container 12 is typically made of a transparent plastic that can be readily molded and is able to withstand the heat treatment temperatures. An example of one suitable plastic is polypropylene, although other heat resistant translucent or transparent plastics can be used.

The container 12 is closed by a suitable lid 22 that can be crimped to the container 12 or attached by an adhesive or other suitable means. Preferably, the lid 22 can be opened by the consumer without the use of tools or openers. In the embodiment shown, the lid 22 includes a weakened score line 24 and a tab or ring 26. The ring 26 can be pulled by the user to separate the center portion of the lid from the perimeter to allow the consumer to access the food product.

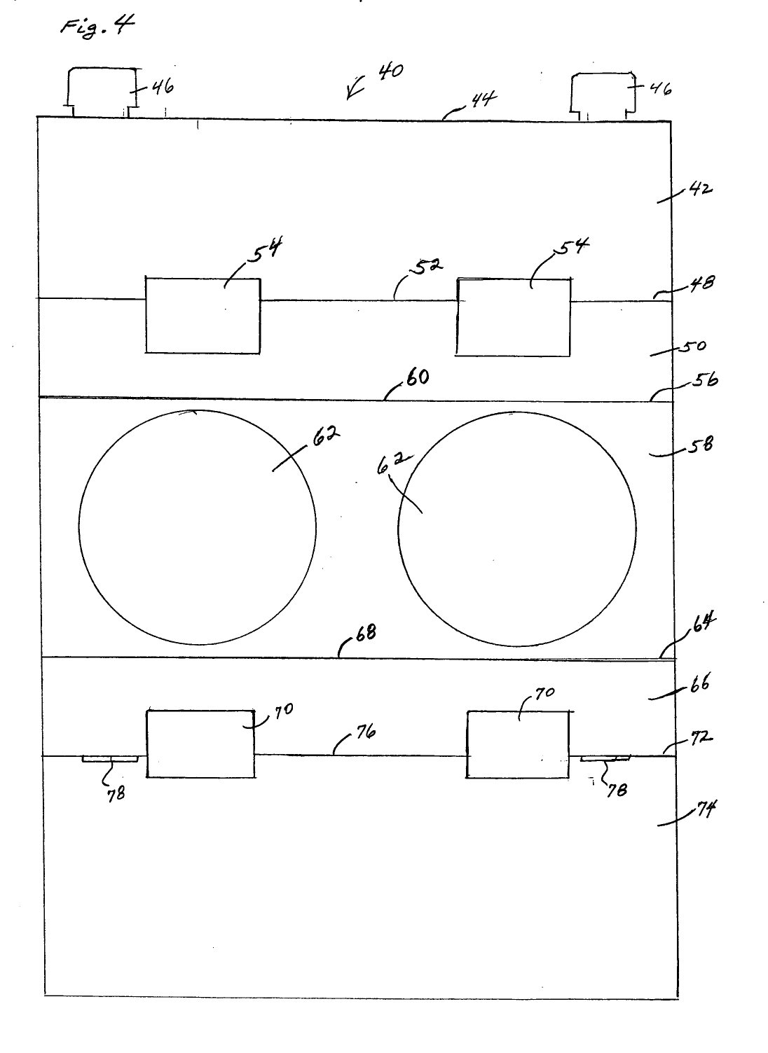

The second container 14 is preferably included to contain a condiment such as a tomato based cocktail sauce, mustard sauce, or the like. In this embodiment, the second container 14 has a bottom wall 28 and frustoconical shaped side wall 30. The side wall 30 has an upper end with a lip 32 that has a removable lid 34. The lip 32 of the second container 14 includes a flange 36 having an outer diameter that is slightly smaller than the inner diameter of the lip of the first container 12 so that the flange 36 of the second container 14 can nest within the lip of the first container 12. In the illustrated embodiment shown in FIGS. 3 and 4, the flange 36 snaps into the lip of the first container 14 to couple the containers together. The containers can be separated and opened by the consumer. In one embodiment, a band 38 of a heat-shrink material surrounds the lips of the containers to secure the containers together.

The packaged assembly can also include a folded cardboard blank 40 to couple the containers together. The blank as shown in FIG. 4 has a substantially rectangular shape with a first bottom panel 42 having a first edge 44 with a pair of tabs 46. The first bottom panel 42 has a second edge 48 connected to a first edge of a first side panel 50 by a fold line 52. The first side panel 50 and the first bottom panel 42 have cut-out windows 54 to view the containers within the package.

The first side panel 50 has a second edge 56 connected to a top panel 58 by a fold line 60. In the embodiment shown, top panel 58 has two spaced-apart circular cut-outs 62 having a diameter complementing the outer diameter of the first container 12 and being smaller than the lip of the first container 12. In this embodiment, the blank 40 is adapted to contain two sets of the containers. In other embodiments, the blank can have a single circular cut-out to receive a single set of containers.

The top panel has a second edge 64 connected to a first edge of a second side panel 66 by a fold line 68. The second side panel 66 is substantially the same size and shape as the first side panel 56 and includes a similar pair of cut-out windows 70. The second panel has a second edge 72 connected to a second bottom panel 74 by a fold line 76. The fold line 76 includes a pair or slits 78 to receive the tabs 46 when the blank is folded.

As shown in FIG. 3, the blank is folded around the containers with the first containers extending through the circular cut-out and the first bottom panel folded to overlap the second bottom panel. The tabs are inserted into the respective slot to couple the bottom panels together. In one preferred embodiment, a shrink-wrap film 80 encircles the assembled containers and the folded cardboard blank.

While various embodiments have been chosen to illustrate the invention, it will be understood by those skilled in the art that various changes and modifications can be made to the invention without departing from the scope of the invention as recited in the appended claims.

What is claimed is:

1. A process for preparing a stable packaged shellfish product comprising the steps of:
heating raw shellfish to a temperature and for a time sufficient to produce a hot partially cooked shellfish;
cooling said hot partially cooked shellfish to a temperature of 32° C. or less to stop the cooking process and produce a cooled partially cooked shellfish;
placing the cooled partially cooked shellfish into a container at an ambient temperature of about 18° C. to about 24° C. and ambient pressure, and thereafter hermetically sealing the container;
heating the partially cooked shellfish in said container to a temperature of at least 62° C. for a time sufficient to produce a fully cooked shellfish; and
immediately thereafter cooling said shellfish to stop the cooking process and storing said shellfish at a temperature below room temperature.

2. The process of claim 1, comprising heating the raw shellfish to a temperature of at least 80° C. for a time sufficient to produce said hot partially cooked shellfish without completely cooking the shellfish.

3. The process of claim 1, comprising steaming said raw shellfish for about 1 minute to about 1.5 minutes to produce said hot partially cooked shellfish.

4. The process of claim 1, wherein said shellfish is shrimp or crab.

5. The process of claim 1, comprising cooling said hot partially cooked shellfish by spraying with chilled water containing about 0.5 wt % to about 2 wt % of an edible acid.

6. The process of claim 5, wherein said edible acid is citric acid.

7. The process of claim 1, wherein said container is a substantially rigid container, and wherein said ambient temperature during sealing of said container substantially prevents deformation of said container during heating or refrigeration.

8. The process of claim 1, further comprising maintaining said hermetically sealed container at a temperature of at least 18° C. between sealing the container and heating the container to fully cook the shellfish.

9. The process of claim 1, comprising cooling said partially cooked shellfish by spraying with a chilled cooling solution, wherein said cooling solution consists essentially of water and about 0.5 wt % to about 2.0 wt % citric acid.

10. The process of claim 1, wherein shellfish in said container is heated to an internal temperature of about 62° C. to about 71 ° C. for about 30 seconds to about 2 minutes to fully cook the shellfish.

11. The process of claim 10, wherein said shellfish and said container are heated by immersing said container in a hot water bath.

12. The process of claim 1, wherein said shellfish is stored at a temperature of about 0° C. to about 4° C.

13. The process of claim 1, comprising cooling said hot partially cooked shellfish by immersing in an ice water bath consisting essentially of water and about 0.5 wt % to about 2.0 wt % citric acid.

14. The process of claim 1, wherein said shellfish is shrimp and said process comprises immersing raw shrimp in boiling water for a time sufficient to produce said hot partially cooked shrimp without completely cooking said shrimp.

15. A process for preparing a stable packaged shrimp product comprising the steps of:
heating raw shrimp to a temperature and for a time sufficient to produce hot partially cooked shrimp;
immediately thereafter contacting the hot partially cooked shrimp with chilled water containing an effective amount of an edible acid to treat the partially cooked shrimp and reduce the temperature of the shrimp to a temperature of 32° C. or less to stop cooking the shrimp and produce a cooled partially cooked shrimp;
placing the cooled partially cooked shrimp in a container at a temperature of about 15° C. to about 28° C. and thereafter hermetically sealing the container;
heating the container and the partially cooked shrimp to a temperature of at least 62° C. for a time sufficient to produce a hot fully cooked shrimp; and
immediately thereafter cooling the hot fully cooked shrimp to a temperature of not more than 10° C. to produce chilled cooked shrimp and storing the fully cooked shrimp under refrigeration.

16. The process of claim 15, wherein said raw shrimp is immersed in water at a temperature of at least 90° C. for a time sufficient to produce said hot partially cooked shrimp.

17. The process of claim 15, wherein said raw shrimp is exposed to live steam for a time sufficient to produce said hot partially cooked shrimp.

18. The process of claim 15, wherein said hot partially cooked shrimp is cooled by spraying with chilled water containing about 0.5 wt % to about 2.0 wt % citric acid.

19. The process of claim 15, wherein said hot partially cooked shrimp is cooled by immersing in cold water consisting essentially of water and about 0.5 wt % to about 2.0 wt % citric acid.

20. The process of claim 15, comprising cooling said hot partially cooked shrimp to a temperature of about 15° C. to about 24° C. to produce said cooled partially cooked shrimp.

21. The process of claim 15, wherein said container is a substantially rigid container and wherein shrimp is at a sufficient temperature at the time of sealing said container to substantially prevent deformation of said container during said heating or storage of said container.

22. The process of claim 21, comprising heating said sealed container by immersing in hot water for a time sufficient to attain an internal temperature of about 62° C. to about 71° C. to produce said hot fully cooked shrimp.

23. The process of claim 15, wherein the container and hot fully cooked shrimp is immersed in a cold water bath at a temperature of about 0° C. to about 4° C. for sufficient time for a time sufficient to stop cooking the shrimp and to attain an internal temperature of 10° C. or less and produce said chilled cooked shrimp.

24. A stable packaged shellfish product prepared by the process comprising the steps of:
heating and partially cooking raw shellfish to a temperature and for a time sufficient to produce a partially cooked shellfish;
immediately thereafter reducing the internal temperature of said partially cooked shellfish to a temperature of 32° C. or less to stop the cooking of the shellfish and produce a cooled partially cooked shellfish;
placing said cooled partially cooked shellfish in a container at an ambient temperature of about 18° C. to about 24° C. and thereafter hermetically sealing said container;
heating said container and said partially cooked shellfish to an internal temperature of at least 62° C. for a time sufficient to produce a fully cooked shellfish; and
immediately thereafter cooling said container and shellfish to stop cooking and produce chilled cooked shellfish, and storing the container and shellfish under refrigeration.

25. The packaged shellfish product of claim 24, wherein said shellfish is shrimp or crab.

26. The packaged shellfish product of claim 24, wherein said packaged shellfish product contains 10 wt % or less liquid phase.

27. The packaged shellfish product of claim 24, wherein said raw shellfish is partially cooked by exposing said raw shellfish to live steam.

28. The packaged shellfish product of claim 24, wherein said raw shellfish is partially cooked by immersing in hot water.

29. The packaged shellfish product of claim 24, wherein said raw shellfish is shrimp and where said shrimp is exposed to live steam for about 1 minute to about 1.5 minutes to produce partially cooked shrimp.

30. The packaged shellfish product of claim 24, wherein said hot partially cooked shellfish is immediately cooled to a temperature of about 15° C. to about 24° C. and thereafter placed in said containers.

31. The packaged shellfish product of claim 24, wherein said container is substantially rigid and wherein said ambient temperature during sealing of said container substantially prevents deforming said container during subsequent heating and cooling.

32. The packaged shellfish product of claim 24, wherein said container and shellfish are heated to an internal temperature of about 62° C. to about 71° C. for about 2 minutes or less.

33. The packaged shellfish product of claim 24, wherein said container has a bottom wall, a side wall forming an open top end of said container, and a removable lid to hermetically seal said container.

34. The packaged shellfish product of claim 33, further comprising a condiment package containing a condiment for said shellfish, said condiment package being coupled to said container.

35. The packaged shellfish product of claim 34, wherein said condiment package has a bottom, a side wall defining a top end and a removable lid coupled to said top end, said top end of said condiment package mating with said top end of said container.

36. The packaged shellfish product of claim 35, further comprising a shrink wrap film coupling said container and said condiment package together.

37. The packaged shellfish product of claim 35, further comprising an outer carton formed from a folded blank, said blank having a top panel, a pair of side panels and a bottom panel, said outer carton coupling said container and said condiment package together.

38. The packaged shellfish product of claim 37, wherein said condiment package has an outer diameter less than an outer diameter of said container, said top panel of said folded blank having an opening for receiving said side wall of said condiment package, whereby said side wall of said condiment package extends through said opening and is retained on said container by said folded blank.
